(19) United States
(12) Patent Application Publication
(10) Pub. No.: US 2018/0018651 A1
(43) Pub. Date: Jan. 18, 2018

(54) GIFT CREATION

(71) Applicant: American Greetings Corporation, Cleveland, OH (US)

(72) Inventors: Gary Nelson, Avon, OH (US); Allison Marsh, Olmsted Township, OH (US); Carol Miller, Twinsburg, OH (US)

(21) Appl. No.: 15/719,048

(22) Filed: Sep. 28, 2017

Related U.S. Application Data
(63) Continuation-in-part of application No. 15/417,074, filed on Jan. 26, 2017.
(60) Provisional application No. 62/287,206, filed on Jan. 26, 2016.
(60) Provisional application No. 62/400,866, filed on Sep. 28, 2016.
(60) Provisional application No. 62/403,600, filed on Oct. 3, 2016.

(51) Int. Cl. G06Q 20/18; B65D 43/14; B65D 25/10; A45C 11/18; B65D 25/54; G06Q 20/32; B65D 51/26

(52) U.S. Cl. CPC G06Q 20/18; G06Q 20/322; B65D 43/14; B65D 51/26; A45C 11/18; B65D 25/54; B65D 25/10; B65D 2203/12

(57) ABSTRACT

A method includes causing a plurality of gift provider options to be provided via a display, receiving a first input indicative of a selection of a gift provider, causing, a plurality of gift values to be provided via the display, receiving a second input indicative of a selection of a desired gift value, requesting payment information corresponding to at least the desired gift value, and receiving a third input including payment information indicative of the desired gift value. The method also includes receiving a unique value code corresponding to the gift provider from a remote processing center, wherein the desired gift value is redeemable from the gift provider using the value code. The method further includes causing a printer to print the unique value code on one of a greeting card or giftable item separate from the greeting card.

### CROSS-REFERENCE TO RELATED APPLICATIONS

The present application is a continuation-in-part of U.S. patent application Ser. No. 15/417,074, filed Jan. 26, 2017, which claims the benefit of U.S. Provisional Patent Application No. 62/287,206, filed Jan. 26, 2016, U.S. Provisional Patent Application No. 62/400,866, filed Sep. 28, 2016, and U.S. Provisional Patent Application No. 62/403,600, filed Oct. 3, 2016. The entire disclosures of the above applications are incorporated herein by reference.

### FIELD OF THE INVENTION

The present disclosure is in the field of social expression products, and more specifically, to generating a gift that includes a unique value code via a kiosk and/or via an application operable on an electronic device separate from the kiosk.

### BACKGROUND

Gift cards that include a stored amount of monetary value have become common birthday gifts, holiday gifts, or gifts during other occasions. However, because such gift cards require the recipient to go to a brick and mortar store, visit a corresponding website, or take other action in order to redeem a gift of their choosing, purchasers of such gift cards often feel that gift cards lack the sentimental value and personal touch that other more traditional gifts may provide. As a result, purchasers of gift cards often purchase a greeting card (e.g., a birthday card, a holiday card, or other occasion-specific card) in conjunction with the gift card. In this way, the gift card may be presented to the recipient on or in the greeting card in order to personalize and enhance the gifting experience for the recipient.

However, the process of purchasing a greeting card and a gift card can be unfulfilling in some situations. For example, the process of selecting a greeting card can be time consuming, as most purchasers will review multiple greeting cards before deciding on a particular card for purchase. Even then, the selected greeting card is not easily modifiable to include customized greetings, messages, photos, and/or other content that is personal to either the purchaser or the recipient. Moreover, including a separate gift card in the greeting when the greeting card is given to the recipient presents the risk that the gift card may be lost by the recipient during or after such an exchange. Further, since the gift card is separate from the greeting card, the gift card and the greeting card typically will not share the same decorations, themes, layout, color scheme, or general appearance. As a result, such a gift combination will lack aesthetic appeal. Moreover, because such gift cards generally include one or more value codes (e.g., a redemption code, an activation code, etc.) the risk for theft and/or fraud associated with such gift cards is high.

The example embodiments of the present disclosure overcome one or more of the deficiencies noted above.

### SUMMARY

The kiosks, electronic devices, user interfaces, and/or other aspects of the present disclosure provide a unique, fun, and personalized way to generate gifts for a recipient. In some examples, the greeting cards described herein provide information required to unlock, redeem, or otherwise provide access to a gift item. Such greeting cards can be customized by the purchaser in a fun, entertaining way using a greeting card kiosk which greatly improves the gift generation process, and provides a meaningful gift giving and receiving experience. In other examples, such information may be provided on a sticker, label, post card, or other giftable item created at the kiosk. In such examples, the separate giftable item can be adhered to and/or otherwise combined with a greeting card by the purchaser prior to gifting. In still other examples described herein, a greeting card and/or a separate giftable item may be generated, at least in part, using the purchaser's mobile electronic device, and a stand alone printer may be used to print such items. In such examples, a kiosk of the present disclosure may not be needed. In still further examples, the greeting card and/or the sticker or other giftable item may be generated, at least in part, on the purchaser's mobile electronic device or using a kiosk. Once generated in this way, the greeting card and/or the sticker or other giftable item may be transferred electronically to the recipient. In such examples, the purchaser may not print such items at a stand alone printer or at the kiosk.

In still further examples, one or more of the gift items described herein may be selected by a purchaser using a kiosk and/or using the purchaser's mobile electronic device. The gift item may then be transferred electronically to the recipient's digital wallet using the kiosk or the purchaser's mobile electronic device. In such examples, the kiosk and/or the user's mobile electronic device may also be used to generate one or more of the greeting cards and/or giftable items described herein. Such greeting cards and/or giftable items may be printed at the kiosk or at a stand-alone printer, and may be physically given to the recipient in combination with the gift item that has been added to his/her digital wallet. Alternatively, in such embodiments the greeting cards and/or giftable items may also be transferred electronically to the recipient.

In an example embodiment of the present disclosure, a kiosk may include a display, a printer, and a controller connected to the display and the printer. The controller may be in communication with memory storing a set of instructions which, when executed by the controller, cause the controller to perform operations. In such examples, the operations may include causing a plurality of greeting card options to be provided via the display, receiving a first input indicative of a selection of a particular greeting card of the plurality of greeting card options, causing a plurality of gift provider options to be provided via the display, and receiving a second input indicative of a selection of a particular gift provider of the plurality of gift provider options. Such operations may also include receiving a third input including payment information, the payment information being indicative of a desired gift value, and receiving a unique value code corresponding to the particular gift provider from a remote processing center and via a network to which to the controller is connected, wherein the desired gift value is redeemable from the particular gift provider using the value code. Such operations may further include causing the printer to print the particular greeting card including the unique value code.

In another example embodiment of the present disclosure, a kiosk may include a display, a printer, and a controller connected to the display and the printer. The controller may be in communication with memory storing a set of instructions which, when executed by the controller, cause the controller to perform operations. Such operations may include causing a plurality of gift provider options to be provided via the display, receiving a first input indicative of a selection of a particular gift provider of the plurality of gift provider options, and receiving a second input including payment information, the payment information being indicative of a desired gift value. Such operations may also include receiving a unique value code corresponding to the particular gift provider from a remote processing center and via a network to which to the controller is connected, wherein the desired gift value is redeemable from the particular gift provider using the value code. Such operations may further include causing the printer to print the unique value code on a giftable item.

In still another example embodiment of the present disclosure, a method includes causing, with a controller, a plurality of gift provider options to be provided via a display, receiving, with the controller, a first input indicative of a selection of a particular gift provider of the plurality of gift provider options, and receiving, with the controller, a second input indicative of a selection of a desired gift value. The method may also include requesting, with the controller and via the display, payment information corresponding to at least the desired gift value, receiving, with the controller, a third input including payment information indicative of the desired gift value. The method may further include providing, with the controller, information indicative of the particular gift provider and the desired gift value to a remote processing center via a network with which the controller is connected. The method may also include receiving, with the controller, a unique value code corresponding to the particular gift provider from the remote processing center and via the network, wherein the desired gift value is redeemable from the particular gift provider using the value code. Such a method may also include causing, with the controller, a printer to print the unique value code on one of a greeting card or giftable item separate from the greeting card.

The various aspects of the different embodiments included herein will be described in further detail below with respect to the figures.

### BRIEF DESCRIPTION OF THE DRAWINGS

This detailed description makes reference to the accompanying figures. In the figures, the left-most digit(s) of a reference number identifies the figure in which the reference number first appears. The same reference numbers in different figures indicate similar or identical items.

FIG. 1 is a schematic view of an example environment of the present disclosure. Such an example environment may include a kiosk having a value code engine configured to assist in generating a greeting card including a unique value code printed thereon, and/or a giftable item including a unique value code printed thereon.

FIG. 2 is a partial schematic view of the kiosk shown in FIG. 1.

FIG. 3 is a flowchart illustrating an example method of the present disclosure.

FIG. 4 illustrates an example user interface associated with generating a greeting card using the kiosk or using a mobile application.

FIG. 5 illustrates another example user interface associated with generating a greeting card using the kiosk or using a mobile application.

FIG. 6 illustrates still another example user interface associated with generating a greeting card using the kiosk or using a mobile application.

FIG. 7 illustrates an example user interface associated with selecting a particular merchant or other gift provider using the kiosk or using a mobile application.

FIG. 8 illustrates an example user interface associated with selecting a desired gift value or amount using the kiosk or using a mobile application.

FIG. 9 illustrates an example user interface associated with providing payment information using the kiosk or using a mobile application.

FIG. 10 is a flowchart illustrating another example method of the present disclosure.

### DETAILED DESCRIPTION

### Overview

Example embodiments of the present disclosure are directed toward kiosks, mobile electronic devices, and/or other components useful in generating a gift. Such a gift may include, for example, a greeting card having a unique value code printed thereon. Alternatively, such a gift may include a greeting card, and a label, sticker, post card, or other separate giftable item configured to be connected to, adhered to, and/or otherwise gifted together with the greeting card, and on which, such a unique value code may be printed. The greeting card and the giftable item may be made of paper, foam, metal, plastic, cardboard, paperboard, chipboard, fiberboard, wood, or any other conceivable material or a combination thereof. The greeting card and the giftable item may contain printing thereon which includes but is not limited to: a picture, a drawing, a photograph, a logo, printed text, instructions for redeeming a gift item, and/or other fanciful designs. In some examples, the greeting card and the giftable item may have matching, common, and/or otherwise coordinated drawings, photographs, logos, text, or other content printed thereon. In such examples, the greeting card and the giftable item may share a common aesthetic design or theme. In still further examples, one or both of the greeting card the separate giftable item may be transferred to a recipient electronically by a purchaser. In such examples, one or both of the greeting card and the separate giftable item may be transferred to a recipient by a kiosk, a mobile electronic device, and/or other component of the present disclosure. Further, in such examples, the greeting card may comprise an electronic greeting card and the giftable item may comprise an electronic giftable item.

In any of the example embodiments described herein, the unique value code included on the greeting card or on the giftable item may be used to unlock, redeem or otherwise provide access to an electronic, a virtual or physical gift item. In some examples, such a gift item may comprise currency (e.g., U.S. dollars), bitcoins, or other forms of transferrable value. Additionally or alternatively, such a gift item may include a subscription to a magazine, newspaper, or other periodical. In still further examples, such a gift item may include one or more of food, wine, books, clothing, lawn and garden items, musical recordings (e.g., individual songs, complete albums, etc.), games, sporting goods, crafts, or any other tangible, intangible, goods or services. Additionally, any of the greeting cards or giftable items described herein may include images, decorations, pictures, slogans, trademarks, and/or other visual indicia that is indicative of the gift item that may be redeemed using the unique value code. Additional examples of gift items that may be redeemed using the unique value code will be described below.

The unique value code may comprise a bar code, a QR code, an alphanumeric code, a digital watermark, and/or any other machine or human-readable code configured to enable activation of the greeting card or giftable item, and/or to enable redemption of the gift item corresponding to the unique value code from a corresponding merchant or gift provider. In some examples, a recipient of the greeting card and/or giftable item may visit a predetermined website (e.g., a website of the corresponding gift provider or a website of the entity that owns or operates the kiosk), and may enter the unique value code into a data entry field on the web site to redeem such a gift item. In other examples, on the other hand, the recipient may visit a predetermined website, and may scan the bar code, QR code, or digital watermark using the recipient's mobile phone or other mobile electronic device to redeem such a gift item. In still further examples, the recipient may visit a brick and mortar store where the unique value code may be used for redemption of the gift item.

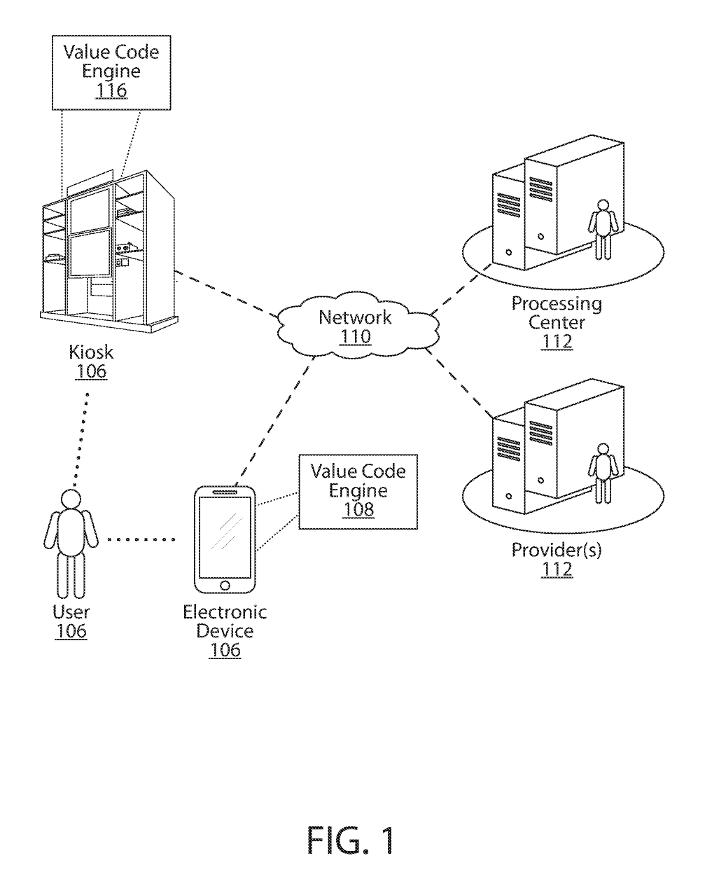

Example embodiments of the present disclosure will be described in greater detail below with respect to the example environment illustrated in FIG. 1.

### Example Environment

FIG. 1 is a schematic diagram of an illustrative computing environment 100 for implementing various gift generation processes. The environment 100 may include one or more users 102 accessing a web-based application via an electronic device 104. In such examples, a greeting card, giftable item, and/or other gift of the present disclosure may be generated and/or gifted (e.g., electronically) by the user 102, at least in part, via such a web-based application. Additionally or alternatively, the environment 100 may include one or more kiosks 106 accessible by the user 102 within a retail establishment, brick and mortar store, and/or other physical location. In such examples, a greeting card, giftable item, and/or other gift of the present disclosure may be generated and/or gifted (e.g., electronically) by the user 102, at least in part, via such a kiosk 106. In such examples, the web-based application described above may be accessed by the user 102 using the kiosk 106, and a greeting card, giftable item, and/or other gift of the present disclosure may be generated and/or gifted (e.g., electronically) by the user 102, at least in part, via the web-based application using the kiosk 106. In any of the examples described herein, the electronic device 104 and/or the kiosk 106 may include respective value code engines 108, 116 or other hardware and/or software components configured to consume information received via such web-based applications, and may be configured to assist in associating a unique value code with ether the greeting card or the giftable item based on such information.

In various embodiments, the electronic devices 104 may include a mobile phone, a portable computer, a tablet computer, an electronic book reader device (an “eBook reader device”), or other devices. Each of the electronic devices 104 may have software and hardware components configured to receive input from the user 104, and to cause the display of the various information, user interfaces, and/or other outputs described herein. The electronic devices 104 noted above are merely examples, and other electronic devices that are equipped with network communication components, data processing components, electronic displays for displaying data, and components configured to receive multiple user inputs may also be employed. Further, the kiosks 106 described herein may include any of the software, hardware, and/or other components described herein with respect to the electronic devices 104.

In some examples, the electronic devices 104 and/or the kiosks 106 described herein may include, among other things, a display component, a digital camera, and/or an audio input and transmission component. Such display components may comprise a touch screen, an LCD display, or other like component configured to display text, images, user interfaces, video, and/or other content associated with generating one or more of the gifts described herein. Such display components may also be configured to display a keyboard, buttons, slider bars, and/or other like controls configured to receive input from the user 102. Additionally or alternatively, the electronic devices 104 and/or the kiosks 106 may include an external keyboard or other such input/output (“I/O”) device configured to receive input from the user 102. Additionally, such audio input and transmission components may include one or more microphones. In such examples, the electronic devices 104 and/or the kiosks 106 may receive inputs (e.g., audible instructions, voice commands, etc.) from the user 102 via a microphone, and the electronic devices 104 and/or the kiosks 106 may be equipped with, for example, voice recognition software configured to process such inputs. Further, the digital cameras of the electronic devices 104 and/or the kiosks 106 may be configured to track, record, and/or otherwise receive gesture inputs from the user 102. In some embodiments, such digital cameras may receive such gesture inputs without contact being made between the user 102 and, for example, the display or other components, controls, or surfaces of the electronic devices 104 and/or the kiosks 106. In such examples, the electronic devices 104 and/or the kiosks 106 may be equipped with, for example, gesture recognition software configured to process such inputs.

The electronic devices 104 and/or the kiosks 106 may also include hardware and/or software that support voice over Internet Protocol (VoIP) as well as any of the display and/or I/O components described herein. As shown in FIG. 1, the electronic device 104 and/or the kiosk 106 may be communicatively connected to a network 110. Thus, the electronic devices 104 and/or the kiosks 106 may further include a web browser that enables the user 102 to navigate to a web page via the network 110. The electronic devices 104 and/or the kiosks 106 may also include and/or be configured to operate one or more web-based applications with or without connectivity to the network 110. In some embodiments, the user 102 may generate one or more of the greeting cards, gift items, and/or other gifts described herein using such a web page and/or such a web-based application (“app”). For example, the user 102 may access and/or otherwise activate an app on the electronic device 104 and/or the kiosk 106, and may utilize various functionality of the app, in concert with a keyboard, camera, microphone, and/or other component of the electronic device 104 and/or the kiosk 106, to generate one or more such gifts. The app may also facilitate the transfer of information to and from a remote processing center 112 via the network 110.

The network 110 may be a local area network (“LAN”), a larger network such as a wide area network (“WAN”), or a collection of networks, such as the Internet. Protocols for network communication, such as TCP/IP, may be used to implement the network 110. Although embodiments are described herein as using a network 110 such as the Internet, other distribution techniques may be implemented that transmit information via memory cards, flash memory, or other portable memory devices.

In example embodiments, the value code engines 108, 116 described above may receive one or more inputs from the user 102 and may generate one or more corresponding outputs based at least in part on such inputs. For example, as will be described below, the user 102 may select one or more merchants or other gift item providers 114 when generating a gift via the web-based application noted above. The user 102 may also select a gift amount associated with the gift item, and/or may provide credit card information and/or other payment information indicative of the gift amount in order to purchase the greeting card and/or the giftable item. Such value code engines 108, 116 may provide such information to one or more processing centers 112 for processing. The processing center 112 may, among other things, validate the authenticity of the user 102, process the payment information provided by the user 102, and/or provide unique value code information to the value code engines 108, 116 at least partly in response to receiving the information from the value code engines 108, 116. Additionally, the processing center 112 may provide such information, at least in part, to the one or more providers 114 corresponding to the gift item, and may activate the unique value code. In some examples, the value code engines 108, 116 described herein may also be configured to assist in causing the received value code to be printed on the greeting card or on the separate giftable item.

The processing centers 112 described herein may include one or more electronic devices (e.g., a server, desktop computer, laptop computer, tablet computer, processor, and/or any other computing device or other components described above with respect to the electronic devices 104 and/or the kiosks 106), human users, information databases, websites, business research companies, and/or any other information source. Any of the example processing centers 112 described herein may be communicatively connected to the electronic devices 104 and/or the kiosks 106 via the network 110, and such processing centers 112 may be disposed at a location remote from the electronic devices 104 and/or from the kiosks 106. As noted above, such processing centers 112 may be configured to receive information, such as payment information, from the electronic devices 104 and/or the kiosks 106. At least partly in response to receiving such information, the processing centers 112 may validate the authenticity of the user 102, process the payment information provided by the user 102, and/or provide unique value code information to the electronic devices 104 and/or the kiosks 106 for use in generating the greeting card and/or the giftable item locally. Additionally, the processing center 112 may provide such information, at least in part, to the one or more providers 114 corresponding to the gift item, and may activate the unique value code. Further, the processing center 112 may facilitate redemption of the gift item corresponding to the unique value code when such redemption is attempted by the gift recipient.

Similar to the processing centers 112, the gift item providers 114 described herein may include one or more electronic devices (e.g., a server, desktop computer, laptop computer, tablet computer, processor, and/or any other computing device or other components described above with respect to the electronic devices 104 and/or the kiosks 106), human users, information databases, websites, and the like. Any of the example gift item providers 114 described herein may be communicatively connected to the processing centers 112 via the network 110, and such providers 114 may be disposed at a location remote from at least the electronic devices 104 and/or from the kiosks 106. The gift item providers 114 may comprise any merchant, seller, manufacturer, service provider, and/or other entity offering a gift item for purchase.

### Example Kiosk

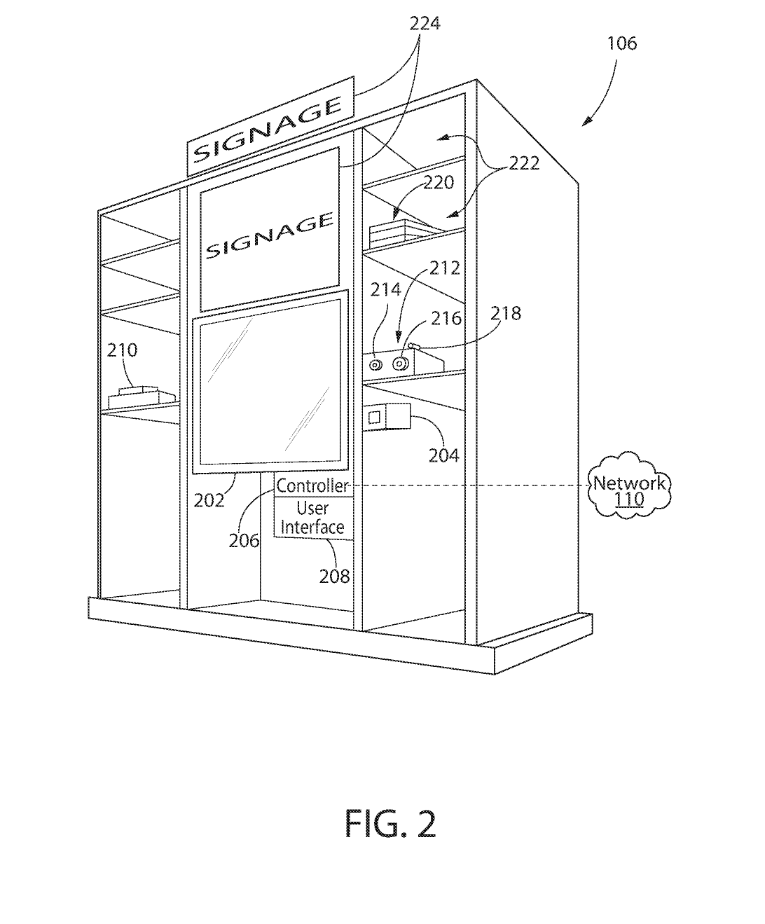

FIG. 2 is a partial schematic illustration of an example kiosk 106 of the present disclosure. As shown in FIG. 2, various kiosks 106 of the present disclosure may include one or more walls, a base, and/or a roof, and may define an at least partially enclosed space that enables a user 102 to focus on designing and/or generating a greeting card, a giftable item, and/or other such gift at a location separate and spaced from a cashier/check-out area of a brick-and-mortar retail environment. Any of the kiosks 106 described herein may enable a user 102 (e.g., a gift purchaser) to generate and/or customize a greeting card, a giftable item, and/or other such gift at a location (e.g., an aisle, and end-cap, a lobby area, a room, etc.) within a brick-and-mortar retail environment. The kiosks 106 of the present disclosure may also be configured to scan one or more pre-made greeting cards, print one or more customized greeting cards, print one or more stickers, labels, or other giftable items, and/or otherwise assist in generating one or more of the gifts described herein. Such kiosks 106 may include any of a variety of components in order to facilitate such functionality.

For example, a kiosk 106 may include one or more displays 202, such as a touch screen, an LCD, a smart display, and/or other such display component. In such examples, the display 202 may be configured to enable a user 102 to choose a color, content, theme, texture, and/or other aspect of the greeting card, giftable item, and/or other such gift. In some examples, the color, content, theme, texture, and/or other aspect of the greeting card may be selected to match that of the separate giftable item of vice versa. The display 202 may also enable the user 102 to select a gift item provider 114 (e.g., the merchant or third party retail partner from whom the corresponding gift item will be redeemed). The display 202 may also enable the user 102 to associated a desired gift value with the greeting card, giftable item, and/or other such gift. As a result, such displays 202 may enable the user 102 to select and/or otherwise personalize the value, appearance, content, and other aspects of the greeting card, giftable item, and/or other such gift. In this way, the display 202 may facilitate a fun, interactive, and dynamic gift creation exercise that can be enjoyable for the user 102.

In some examples, the display 202 may be configured to display and/or otherwise present targeted content to users 102. For example, the display 202 may enable the supplier of the greeting cards and/or the providers 114 to present content that is intended to enhance the user experience and/or to entice the user 102 into purchasing various greeting cards, gift items, or other products/services. Such audio, video, and/or other content may include advertisements, suggested themes, suggested gift items, suggested automation, suggested music, suggested messages, and/or other content that the user 102 may consume and/or use when designing a unique greeting card, and/or when purchasing a gift item via the kiosk 106. In some examples, such content may further enhance the gift creation experience.

In some examples, the display 202 may comprise a smart display configured to enable the user 102 to scan one or more greeting cards for purchase, activation, configuration (e.g., loading value, content, etc.) and/or other purposes. In other examples, the kiosk 106 may include one or more dedicated scanners 204 configured to enable such functionality. Such scanners 204 may comprise, for example, an RFID scanner, an infrared scanner, a barcode scanner, a QR code scanner, or other device. Scanning one or more items using the display 202 and/or the scanner 204 of the kiosk 106 may enable the user 102 to, among other things, purchase and/or activate such items at the kiosk 106 (e.g., a user 102 may use a credit card, debit card, PayPal, Apple Pay, an electronic wallet accessible via an electronic device 104, and/or other methods to purchase such items at the kiosk 106), rather than needing to bring such items to a retail outlet cashier. Accordingly, the kiosk 106 and its various components, may enable a user 102 to assemble, generate, purchase, and/or activate a greeting card, giftable item, and/or other gifts without interacting with the retail outlet cashier. Such a process flow (e.g., avoiding the need to complete a sales transaction at the retail outlet cashier) may be preferable for the user 102, and may further enhance the gift generation and/or purchase experience described herein.

When generating and/or purchasing a greeting card, giftable item, and/or other gifts at the kiosk 106, the selection of a particular gift provider 114, a desired gift value (e.g., a dollar amount), credit card information, and/or other payment information may be provided by the user 102. During this process, such information may be linked or otherwise associated with the particular greeting card and/or giftable item being purchased. This information may be stored in a remote database associated with the processing center 112 in communication with the kiosk 106. Additionally, or alternatively, such information may be stored locally at the kiosk 106 in memory associated with and/or in communication with a processor or other such controller 206 associated with the kiosk 106. In some examples, the remote database of the processing center 112 may be in communication with the controller 206 via one or more of the networks 110 described above. The kiosk 106 may also include one or more keyboards, mice, touch pads, and/or other user interfaces 208 in communication with the controller 206 and/or with the display 202. Such user interfaces 208 may further assist the user 102 with storing, accessing, and/or manipulating such information, as well as with any of the purchasing, activating, or other activities performed at the kiosk 106.

The kiosk 106 may also include one or more components configured to assist the user 102 in formatting, creating, and/or generating the greeting card, giftable item, and/or other gifts. For example, the user 102 may use the display 202, the controller 206, the user interface 208, and/or other components of the kiosk 106 to create, view, and/or select content to be associated with greeting card, giftable item, and/or other gifts. Once the user 102 has selected such content, the user may utilize a printer 210 (e.g., a standard printer, ink jet printer, laser jet printer, or a three-dimensional (3D) printer) of the kiosk 106 to print a newly designed greeting card using card stock or other materials 220 located at or near the kiosk 106. In such examples, the printer 210 may also print a bar code, QR code, alphanumeric code, and/or other unique value code on the greeting card so that a corresponding gift item may be redeemed by the recipient of the greeting card. Additionally or alternatively, the user 102 may select a pre-made greeting card from an aisle, card mall, or other location near the kiosk 106. In such examples, the user 102 may also print a bar code, QR code, alphanumeric code, and/or other unique value code on a sticker, label, post card, and/or other materials 220 located at or near the kiosk 106. Such additional giftable items may then be placed on or within the pre-made greeting card, and together, such items may comprise one or more gifts of the present disclosure.

For example, the kiosk 106 may include one or more shelves or other compartments 222 configured to retain substantially blank card stock, labels, stickers, postcards, greeting cards, or other such materials 220. Once the user 102 has generated and/or selected content to be include in a customized greeting card, the user 102 may insert the materials 220 into the printer 210, one or more memory programing devices, and/or other components of the kiosk 106 configured to format the greeting card. Such components may, for example, print a barcode, QR code, unique value code, image, and/or any other content onto the materials 220. In some examples, the kiosk 106 may also include one or more placards, banners, advertisements, or other like signage 224, and such signage 224 may advertise and/or otherwise identify one or more functions of the kiosk 106 in order to pique the interest of the consumer in a crowded retail outlet setting.

As shown in FIG. 2, the kiosk 106 may also include one or more additional input/output (I/O) devices 212 configured to assist the user 102 in generating one or more of the greeting cards, giftable items, and/or other gifts described herein. For example, such I/O devices 212 may include one or more cameras 214 (e.g., a digital camera or other digital imaging device), one or more speakers 216 or other audio output devices, and/or one or more microphones 218 or other audio recording devices. In some examples, one or more of the I/O devices 212 of the kiosk 106 may be combined into a single unit. In other examples, on the other hand, one or more such I/O devices 212 may be a separate and/or stand-alone component of the kiosk 106. Any of the I/O devices 212 may be operably connected to the controller 206, and any of the content generated by the user via such I/O devices 212 may be stored in any of the local or remote databases described above associated with the controller 206. Further, any of the images, audio messages, video messages, text, or other content generated by the user at the kiosk 106 using such I/O devices 212 and/or using the display 202 or other components of the kiosk 106 may be stored on, printed on, etched on, adhered to, and/or otherwise combined with the greeting cards, giftable items, and/or other gifts described herein.

Further, in additional embodiments any of the kiosks 106 described herein may comprise one or more devices within the user's home or at any other location outside of the brick-and-mortar retail environments described herein. For example, in additional embodiments one or more of the kiosk components described herein (e.g., the display 202, controller 206, user interface 208, printer 210, I/O devices 212 camera 214, speakers 216, and/or other components) may comprise components of a gift assembly device (not shown) disposed, for example, at the home of the user 102. In such example, any of the gift/content selection, generation, purchasing, and/or activation activities described herein may be performed using such a gift assembly device and without visiting an example kiosk 106 that is located in a brick-and-mortar retail environment. Such example gift assembly devices may comprise an example electronic communication device of the present disclosure, and such devices may make it easier for users 102 to generate, purchase, and/or activate one or more of the gifts described herein.

### Example Methods

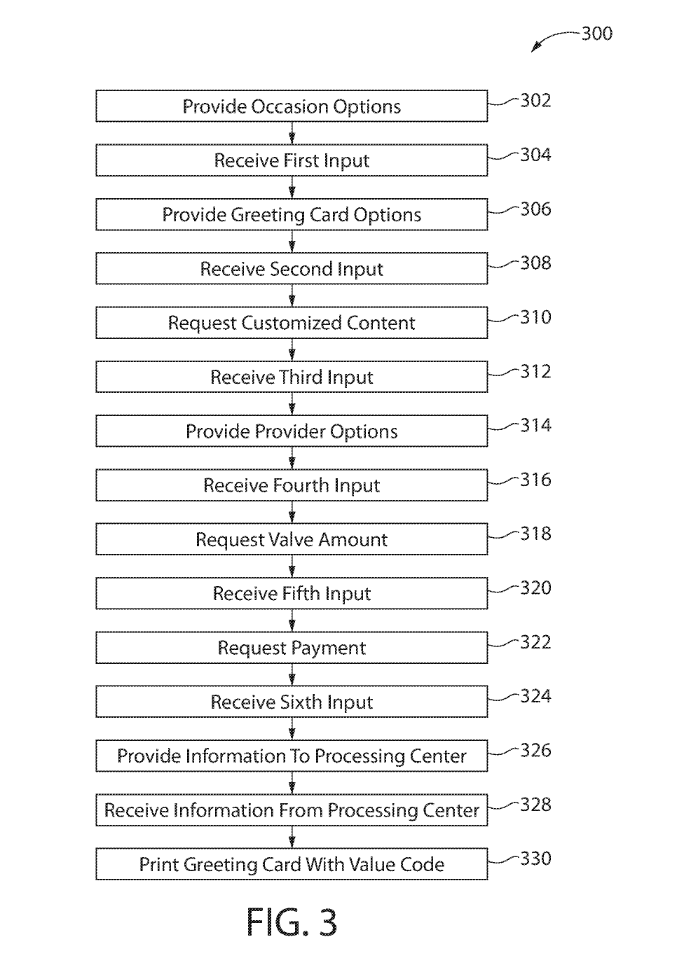

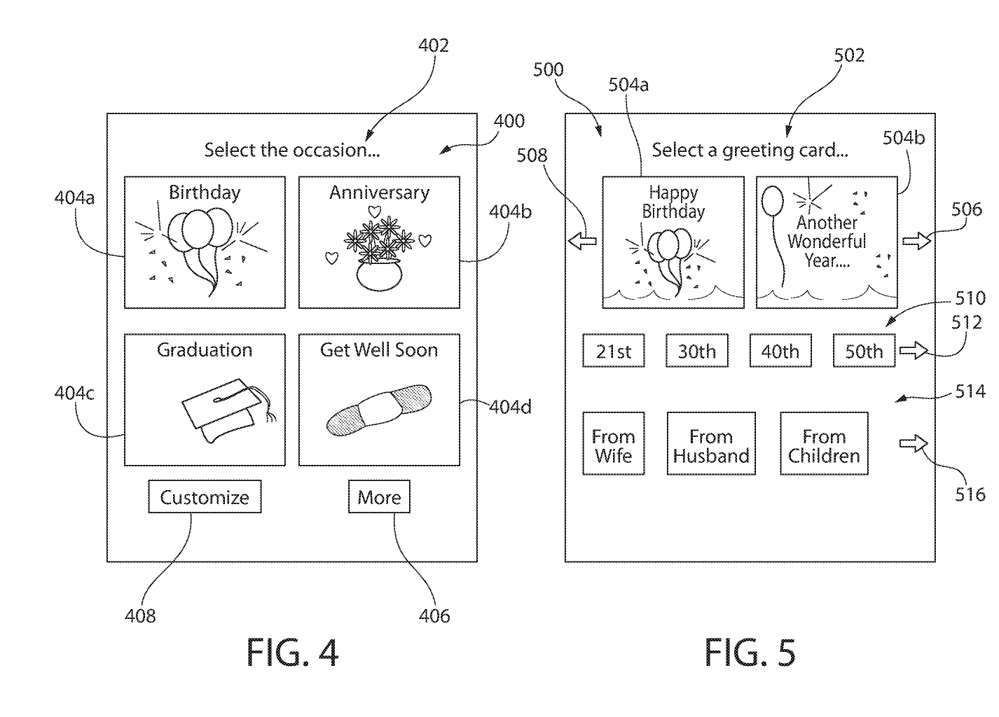

In example embodiments, one or more of the devices described herein with respect to FIGS. 1 and 2 may comprise a system configured to perform various operations associated with generating a greeting card, a giftable item, and/or other such gifts. For instance, the flowchart shown in FIG. 3 illustrates an example method 300 of the present disclosure associated with generating a gift. In addition, as will be noted below, FIGS. 4-9 provide further detail related to various aspects of the method 300. In the example method 300, one or more of the kiosks 106 described herein may be configured to perform one or more operations associated with generating such gifts without the use of, for example, a separate electronic device 104. Additionally or alternatively, in the method 300 one or more of the electronic devices 104 may be configured to perform one or more such operations without the use of a kiosk 106. In still further examples, in the method 300 one or more operations associated with generating one or more such gifts may be performed by a kiosk 106, and one or more additional operations associated with generating such gifts may be performed by an electronic device 104.

The example method 300 of FIG. 3 is illustrated as a collection of steps in a logical flow diagram, which represents a sequence of operations that can be implemented in hardware, software, or a combination thereof. In the context of software, the steps represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described steps can be combined in any order and/or in parallel to implement the process. For discussion purposes, and unless otherwise specified, the method 300 is described with reference to the environment 100 of FIG. 1 and the kiosk 106 illustrated in FIG. 2

With reference to FIG. 3, at 302, a controller 206 of the kiosk 106 may cause a plurality of occasion options to be provided to a user 102 of the kiosk 106 via the display 202. For example, as illustrated in FIG. 4, as part of the process of generating a greeting card, giftable item, and/or other gift using the kiosk 106, the controller 206 may cause an example user interface 400 to be displayed by the display 202. Such a user interface 400 may include, for example, one or more messages 402 assisting the user 102 in generating a greeting card. In the example shown in FIG. 4, such a message 402 may include a request that the user select an occasion option from a plurality of different occasion options included in the user interface 400. For example, at 302, the controller 206 may cause the display 202 to display a plurality of thumbnails 404a, 404b, 404c, 404d. . . 404n (collectively, “thumbnails 404”), and each thumbnail of the plurality of thumbnails 404 may correspond to and/or may otherwise identify a respective occasion option of the plurality of occasion options. For example, in the example user interface 400 illustrated in FIG. 4, the thumbnail 404a corresponds to a “birthday” occasion option, the example thumbnail 404b corresponds to an “anniversary” occasion option, the thumbnail 404c corresponds to a “graduation” occasion option, and the thumbnail 404d corresponds to a “get well soon occasion” option, etc.

It is understood that one or more greeting cards of the present disclosure may be printed at the kiosk 106 based at least in part on the selection of a particular occasion option via the user interface 400. For example, providing an input via the user interface 400, and indicative of a selection of the “birthday” occasion option associated with thumbnail 404a, may cause the controller 206 to provide the user 102 with additional greeting card design options that correspond to various different birthday occasions. Thus, such an input provided via the user interface 400 may assist the user 102 narrowing the formatting, and/or design options associated with the resulting greeting card. Further, the example user interface 400 may include one or more additional controls associated with designing and/or customizing a greeting card via the kiosk 106. For example, user interface 400 may include one or more controls 406 operable to provide the user 102 with additional occasion options via the display 202. The user interface 400 may also include one or more controls 408 operable to enable the user 102 to customize and/or design his or her own greeting card without the use of stored and/or predesigned greeting card formats.

At 304, the controller 206 may receive a first input from the user 102. In such examples, the first input received at 304 may be indicative of a selection of a particular occasion option via one or more of the thumbnails 404 described above. In such examples, at 304 the user 102 may provide a touch input via the display 202, a voice input via the microphone 218, a gesture input via the camera 214, and/or one or more other inputs via the user interfaces 208 and/or other I/O devices 212 described above.

At 306, the controller 206 may cause a plurality of greeting card options to be provided to the user 102 via the display 202. For example, upon receiving the first input at 304, the controller 206 may provide filtered and/or otherwise targeted greeting card options to the user 102 based at least partly on such input. For example, FIG. 5 illustrates an example user interface 500 generated by the controller 206 based at least partly on the selection of the birthday occasion option associated with the thumbnail 404a (FIG. 4). As noted above, providing an input via the user interface 400, and indicative of a selection of the birthday occasion option associated with thumbnail 404a, may cause the controller 206 to provide the user 102 with additional greeting card design options that correspond to various different birthday occasions. The example user interface 500 may include, for example, one or more messages 502 assisting the user 102 in selecting a stored and/or predesigned greeting card. In the example shown in FIG. 5, such a message 502 may include a request that the user 102 select a particular predesigned greeting card from a plurality of greeting card options provided via the user interface 500. For example, at 306, the controller 206 may cause the display 202 to display a plurality of thumbnails 504a, 504b 504n (collectively, “thumbnails 504”), and each thumbnail of the plurality of thumbnails 504 may correspond to, may be representative of, and/or may otherwise identify a respective predesigned greeting card of the plurality of greeting card options corresponding to the selected occasion.

It is understood that one or more greeting cards of the present disclosure may be printed at the kiosk 106 based at least in part on the selection of a particular predesigned greeting card via the user interface 500. For example, providing an input via the user interface 500, and indicative of a selection of the particular “happy birthday” greeting card associated with thumbnail 504a, may cause the controller 206 to provide the user 102 with additional greeting card design and/or customization options that correspond to the particular selected greeting card. Thus, such an input provided via the user interface 500 may assist the user 102 in selecting a particular greeting card and finalizing its design. Further, the example user interface 500 may include one or more additional controls associated with selecting a particular greeting card via the kiosk 106. For example, user interface 500 may include one or more controls 506, 508 (e.g., forward and back controls) operable to enable the user 102 to browse through various additional greeting cards associated with the plurality of greeting card options. The user interface 500 may also include one or more additional controls 510, 512 associated with various landmark birthdays to assist the user 102, in selecting a corresponding greeting card. User interface 500 may further include one or more additional controls 514, 516 associated with birthday cards from a wife, a husband, children, and/or other family members or friends. Such controls may further assist the user 102, in selecting a particular greeting card via the kiosk 106.

At 308, the controller 206 may receive a second input from the user 102. In such examples, the second input received at 308 may be indicative of a selection of a particular greeting card via one or more of the thumbnails 504 described above. In such examples, at 308 the user 102 may provide a touch input via the display 202, a voice input via the microphone 218, a gesture input via the camera 214, and/or one or more other inputs via the user interfaces 208 and/or other I/O devices 212 described above.

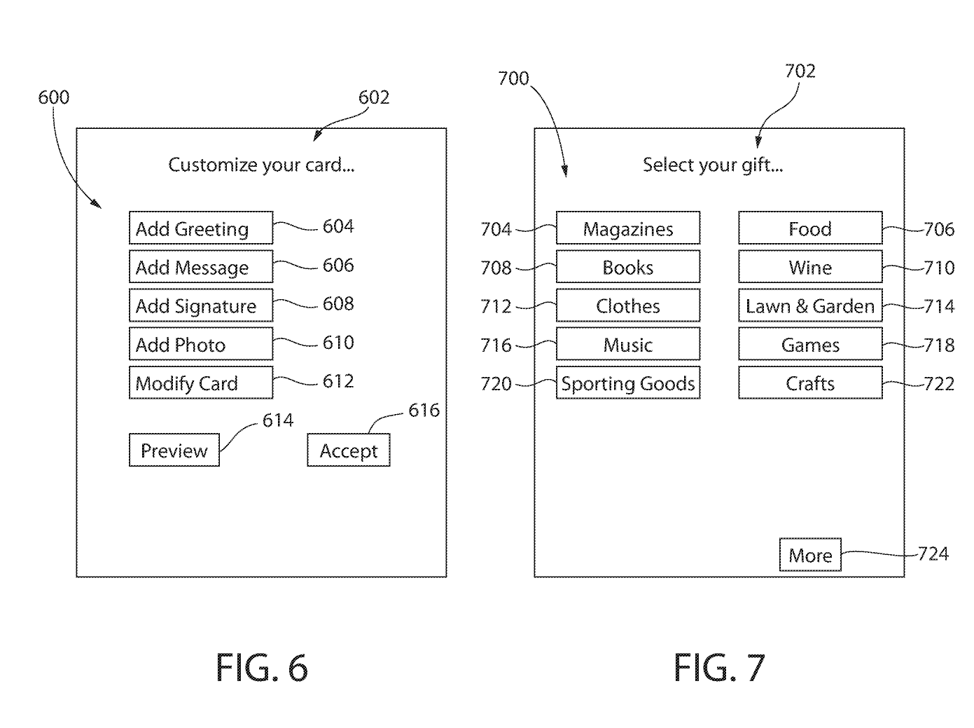

At 310, the controller 206 may cause one or more requests for customized content to be displayed via the display 202. In some examples, the controller 206 may request such customized content at 310 at least partly in response to receiving the second input at 308. For example, upon receiving the second input at 308, the controller 206 may provide tailored customization options to the user 102 based at least partly on the format and/or design of the particular selected greeting card. FIG. 6 illustrates an example user interface 600 generated by the controller 206 based at least partly on the selection of a particular birthday card at 308. The example user interface 600 may include, for example, one or more messages 602 assisting the user 102 in customizing the selected predesigned greeting card. In the example shown in FIG. 6, such a message 602 may include a request that the user 102 select one or more customization options provided via the user interface 600. For example, at 310, the controller 206 may cause the display 202 to display a plurality of controls 604, 606, 608, 610, 612, and each control may correspond to a corresponding customization option. For example, the control 604 may enable the user 102 to add a customized greeting, the control 606 may enable the user 102 to add a customized message to the recipient of the greeting card, the control 608 may enable the user 102 to add his or her signature to the greeting card, the control 610 may enable the user 102 to add one or more photographs to the greeting card, and the control 612 may enable the user 102 to make one or more additional modifications to the greeting card. Further, the user interface 600 may include a control 614 enabling the user 102 to preview a draft of the greeting card before such customizations have been finalized and/or before the controller 206 causes the printer 210 to print the greeting card. For example, the method 300 may include receiving an input via the preview control 614 at 312. In such example methods, the controller 206 may cause the display 202 to provide a preview of at least part of the particular greeting card. The user 102 may view the preview (e.g., images of the greeting card including one or more customizations made using the user interface 600) of the greeting card via the display, and the user 102 may accept the greeting card using the control 616. The user interface 600 may also include a control 616 enabling the user 102 to accept the modifications made to the greeting card via the user interface 600.

At 312, the controller 206 may receive a third input from the user 102. In such examples, the third input received at 312 may include at least one of a customized greeting, a customized message, a customized signature, one or more photographs, and/or any other modifications described above. In such examples, one or more of the photographs provided at 312 may include digital images and/or other photographs captured by an electronic device 104 of the user 102, and transferred from the electronic device 104 to the kiosk 106 (e.g., via Bluetooth, via the network, 110, via near-field communication, via Wi-Fi, etc.) at 312. In further examples, one or more of the photographs provided at 312 may include digital images and/or other photographs captured by the camera 214 of the kiosk 106. In such examples, at 312 the user 102 may provide a touch input via the display 202, a voice input via the microphone 218, a gesture input via the camera 214, and/or one or more other inputs via the user interfaces 208 and/or other I/O devices 212 described above.

At 314, the controller 206 may cause a plurality of gift provider options to be provided to the user 102 via the display 202. For example, as described above, gift items from a plurality of different merchants, retailers, service providers, and/or other gift providers may be incorporated into a gift generated using the kiosk 106. Such gift items may include, for example, gift subscription services or memberships which deliver virtual, electronic or physical goods on a recurring basis (e.g., monthly, quarterly, annually) such as magazine or newspaper subscriptions (e.g., People, Sports Illustrated, Time, Vogue, The New York Times, The Wall Street Journal), makeup or lifestyle subscriptions (e.g., BirchBox, Pop Sugar, Barkbox, Fitbox), a food subscription (e.g., Graze, HelloFresh, various food/drink of the month clubs including, but not limited to: beer, wine, tea, coffee, fruit, candy, etc.), a novelty/gaming item subscription (e.g., Gamefly, LootCrate, Nerd Block), a clothing subscription (e.g., Stitchbox, Bombfell), or any other subscription-based service. Such example gift items may also include one or more electronic items including, but not limited to a game, a movie, a movie clip, a video, a digital book, a digital magazine, a digital magazine subscription, an audio file or audio clip, or a music file. Such example gift items may further include one or more physical gifts or items such as a book, a game, jewelry, clothing, shoes, food items, wine, lawn and garden items, sporting goods, crafts, or any other physically gifted item. In another embodiment, such gift items may include or more services or experiences, such as spa services, beauty services, concerts, sporting events, etc. In still further embodiments, such a gift item may comprise an amount of monetary value (e.g., U.S. dollars), bitcoin, or other transferrable form of funds. As will be described below, in some examples, the greeting card generated by the kiosk 106 may include a unique value code that may be used by the recipient of the greeting card to redeem the one or more gift items associated with the greeting card.

FIG. 7 illustrates an example user interface 700 generated by the controller 206 and provided to the user 102 at 314. The example user interface 700 may include, for example, one or more messages 702 assisting the user 102 in selecting a gift provider 114 and/or a gift item to be associated with the selected greeting card. In the example shown in FIG. 7, such a message 702 may include a request that the user 102 select one or more gift categories provided via the user interface 700. For example, at 314, the controller 206 may cause the display 202 to display a plurality of controls 704, 706, 708, 710, 712, 714, 716, 718, 720, 722, etc. Each such control may correspond to a respective gift category. It is understood that in response to receiving an input via one such control, controller 206 may provide the user 102 with a plurality of gift provider options corresponding to the gift category associated with the selected control. For example, receiving an input via the “food” control 706 would cause the controller 206 to provide the user 102 with a plurality of restaurants, caterers, or other providers 114 of food-related gift items via the display 202. The user interface 700 may also include one or more additional controls 724 enabling the user 102 to view additional gift item categories via the display 202.

At 316, the controller 206 may receive a fourth input from the user 102. In such examples, the fourth input received at 316 may be indicative of a selection of a particular gift provider 114 of the plurality of gift provider options provided to the user at 314. In such examples, at 316 the user 102 may provide a touch input via the display 202, a voice input via the microphone 218, a gesture input via the camera 214, and/or one or more other inputs via the user interfaces 208 and/or other I/O devices 212 described above.

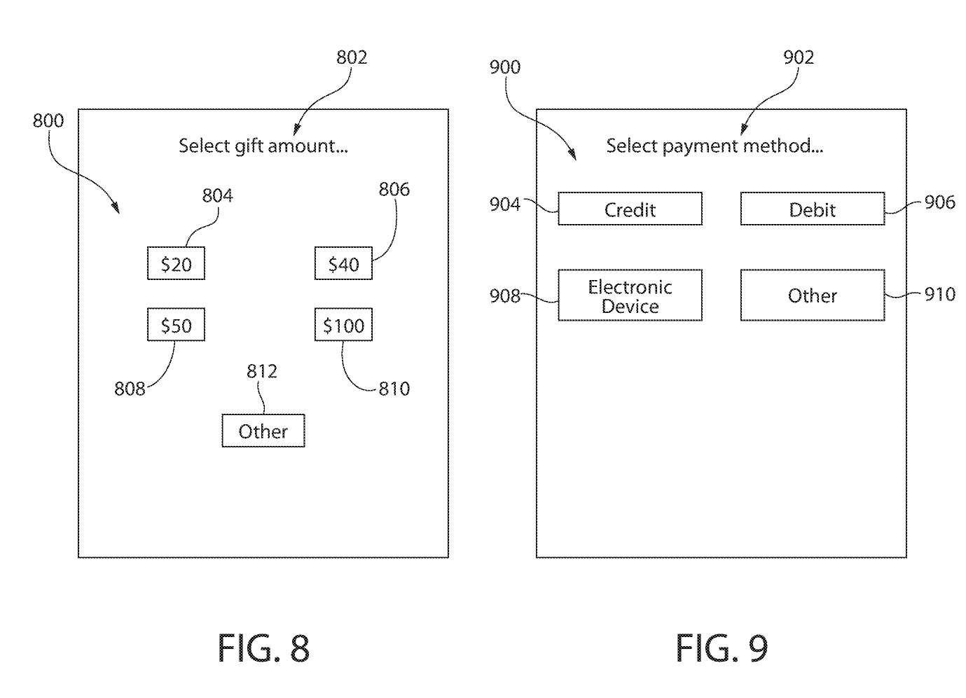

At 318, the controller 206 of the kiosk 106 may request that the user 102 select a desired gift value amount associated with the gift item chosen at 316. For example, at 318 the controller 206 may cause a plurality of gift values and/or gift amounts to be provided to the user 102 via the display 202. FIG. 8 illustrates an example user interface 800 generated by the controller 206 and provided to the user 102 at 318. The example user interface 800 may include, for example, one or more messages 802 assisting the user 102 in selecting a desired gift value corresponding to the selected gift item. In the example shown in FIG. 8, such a message 802 may include a request that the user 102 select one of a plurality of gift values and/or gift amounts provided via the user interface 800. For example, at 318, the controller 206 may cause the display 202 to display a plurality of controls 804, 806, 808, 810, etc. Each such control may correspond to a respective gift value and/or gift amount. It is understood that in response to receiving an input via one such control, controller 206 may provide the user 102 with a further user interface enabling the user 102 to provide payment information that is indicative of the desired gift value selected by the user 102 via the user interface 800. The user interface 800 may also include one or more additional controls 812 enabling the user 102 to enter and/or select a different or customized gift value.

At 320, the controller 206 may receive a fifth input from the user 102. In such examples, the fifth input received at 320 may be indicative of a selection of a desired gift value from the plurality of gift values provided to the user 102 at 318 (e.g., via the user interface 800). In such examples, at 320 the user 102 may provide a touch input via the display 202, a voice input via the microphone 218, a gesture input via the camera 214, and/or one or more other inputs via the user interfaces 208 and/or other I/O devices 212 described above.

At 322, the controller 206 of the kiosk 106 may request that the user 102 select a payment method. For example, at 322 the controller 206 may cause a plurality of payment method options to be provided to the user 102 via the display 202. FIG. 9 illustrates an example user interface 900 generated by the controller 206 and provided to the user 102 at 322. The example user interface 900 may include, for example, one or more messages 902 assisting the user 102 in selecting a particular payment method. In the example shown in FIG. 9, such a message 902 may include a request that the user 102 select one of a plurality of payment options supported by the kiosk 106. For example, at 322, the controller 206 may cause the display 202 to display a plurality of controls 904, 906, 908, etc. Each such control may correspond to a respective payment option (e.g., credit, debit, payment through an electronic wallet accessible via an electronic device 104 of the user 102, PayPal, Apple Pay, etc.). The user interface 900 may also include one or more additional controls 912 enabling the user 102 to enter and/or select a different payment method or other option. It is understood that in response to receiving an input via one such control, controller 206 may provide the user 102 with a further user interface enabling the user 102 to provide the user's credit card number, debit card number, bank account information, PayPal credentials, and/or other payment information such that payment may be made for the greeting card and for the additional gift item described above.

At 324, the controller 206 may receive a sixth input from the user 102. In such examples, the sixth input received at 324 may include at least part of the payment information described above. In example embodiments, such payment information may include a total amount of the transaction (with any appropriate taxes of other fees) performed by the user 102 at the kiosk 106. Thus, the payment information provided at 324 may be indicative of the desired gift value selected by the user 102 via the user interface 800. Such payment information may also be indicative of the costs associated with generating the greeting card via the kiosk 106. In such examples, at 324 the user 102 may provide a touch input via the display 202, a voice input via the microphone 218, a gesture input via the camera 214, and/or one or more other inputs via the user interfaces 208 and/or other I/O devices 212 described above.

At 326, the controller 206 of the kiosk 106 (e.g., the value code engine 116 and/or other hardware or software components associated with the controller 206) may provide information indicative of the gift provider selected at 316 and/or indicative of the desired gift value received at 320 to the remote processing center 112 via the network 110. In such examples, the remote processing center 112 may utilize such information to link the selected gift item with a corresponding provider 114 selected at 316. The remote processing center 112 may also perform one or more operations at 326 and based at least in part on the information received from the controller 206. Such operations may include, among other things, authenticating the user 102, generating a unique value code corresponding to the selected gift item, and/or facilitating payment to the corresponding provider 114. For example, the unique value code generated by the remote processing center 112 may uniquely identify the selected gift item, the corresponding provider 114, and/or the actual gift value paid by the user 102 at 324. The processing center 112 may use this information to allocate payment to the provider 114. The processing center 112 may also store such information such that the recipient of the gift may be authenticated when the recipient attempts to redeem the gift item using the unique value code.

At 328, the controller 206 (e.g., the value code engine 116 and/or other hardware or software components associated with the controller 206) may receive various transaction information from the remote processing center 112. For example, at 328 the controller 206 may receive the unique value code from the remote processing center 112. As noted above, the unique value code may correspond to and/or uniquely identify the selected gift item, the corresponding provider 114, and/or the actual gift value paid by the user 102 at 324. In such examples, the unique value code may be received at 328 via the network 110, and the unique value code may be received at least partly in response to the information provided by the controller 206 at 326.

At 330, the controller 206 (e.g., the value code engine 116 and/or other hardware or software components associated with the controller 206) may cause the printer 210 to print the finalized greeting card including the unique value code. For example, the printer 210 may print the greeting card on card stock or other materials 220 located at or on the kiosk 106, and the printer 210 may print the unique value code received at 328 directly on a surface of the greeting card. As will be described below, the recipient of the greeting card may use the unique value code to redeem the corresponding gift item in one of several ways.

Additionally or alternatively, in any of the examples described herein, at 330 the controller 206 (e.g., the value code engine 116 and/or other hardware or software components associated with the controller 206) may cause the gift item corresponding to the unique value code to be transferred electronically to the recipient's digital wallet and/or other app or component of the recipient's electronic device. In examples in which one or more operations of the method 300 are performed by the user's electronic device 104, such components of the electronic device (instead of the kiosk 106) may also cause the gift item corresponding to the unique value code to be transferred electronically to the recipient's digital wallet and/or other app or component of the recipient's electronic device. In such examples, the kiosk 106 and/or the user's electronic device 104 may also be used to generate one or more of the greeting cards and/or giftable items described herein. Such greeting cards and/or giftable items may be printed by the printer of 210 the kiosk 106, or at a stand-alone printer remote from the kiosk 106, and may be physically given to the recipient by the user 102 in combination with the gift item that has been added to the recipient's digital wallet. Alternatively, in such embodiments the greeting cards and/or giftable items may also be transferred electronically to the recipient. As still another alternative, in any of the examples described herein with respect to the method 300, the unique value code may be emailed, texted (via SMS messaging), transferred via Bluetooth, transferred via NFC, or via other means, and/or otherwise transferred electronically to the recipient from the kiosk 106 and/or from the electronic device 104 of the user 102. In such examples, the greeting card and/or the giftable item may or may not be printed.

Although flow chart described above with respect to FIG. 3 illustrates an example method 300 in which a greeting card may be selected, customized and/or printed at a kiosk 106, in further example embodiments, one or more pre-printed greeting cards may also be used to provide a gift item to a recipient. In such examples, a sticker, label, post card and/or other giftable item separate from the greeting card may be adhered to, connected to, and/or otherwise associated with the greeting card before the greeting card is given to the recipient. Additionally, one or more printers of the present disclosure, such as the printer 210 of the kiosk 106 may be configured to print a unique value code on such a separate giftable item such that a corresponding gift item may be redeemed by the gift recipient using the unique value code.

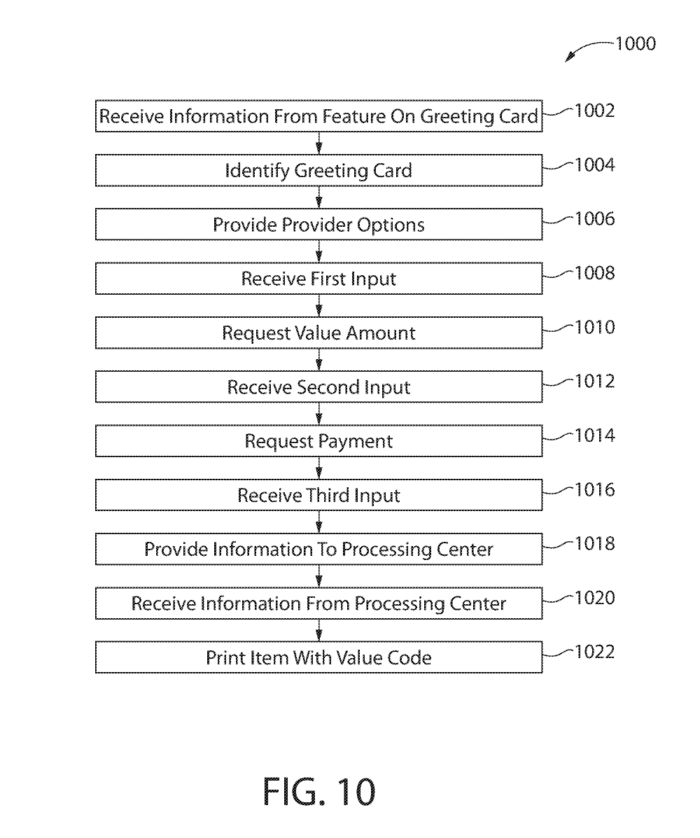

For example, the flowchart shown in FIG. 10 illustrates another example method 1000 of the present disclosure associated with generating a gift. In addition, as will be noted below, at least FIGS. 7-9 provide further detail related to various aspects of the method 1000. In the example method 1000, one or more of the kiosks 106 described herein may be configured to perform one or more operations associated with generating such gifts without the use of, for example, a separate electronic device 104. Additionally or alternatively, in the method 1000 one or more of the electronic devices 104 may be configured to perform one or more such operations without the use of a kiosk 106. In still further examples, in the method 1000 one or more operations associated with generating one or more such gifts may be performed by a kiosk 106, and one or more additional operations associated with generating such gifts may be performed by an electronic device 104.

The example method 1000 of FIG. 10 is illustrated as a collection of steps in a logical flow diagram, which represents a sequence of operations that can be implemented in hardware, software, or a combination thereof. In the context of software, the steps represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described steps can be combined in any order and/or in parallel to implement the process. For discussion purposes, and unless otherwise specified, the method 1000 is described with reference to the environment 100 of FIG. 1 and the kiosk 106 illustrated in FIG. 2

With reference to FIG. 10, at 1002, a controller 206 of the kiosk 106 may receive information from an information feature disposed on a greeting card. For example, a user 102 (e.g., a purchaser of the greeting card) may shop in a conventional greeting card aisle, greeting card mall, and/or other typical retail location in order to find a pre-printed greeting card that is suitable for gifting to a desired recipient. While such a process can be laborious and time-consuming, in some situations, the user 102 may prefer to purchase such a pre-printed greeting card rather than generating, and/or customizing a greeting card as described above with respect to the method 300. In such examples, the pre-printed greeting card selected by the user 102 may include a bar code, QR code, an alphanumeric code, and/or other such code printed thereon. In such examples, the user 102 may provide, for example, the alphanumeric code to the controller 206 of the kiosk 106 using one or more of the user interfaces 208 and/or other I/O devices 212 described above. Alternatively, the user 102 may scan the barcode and/or QR code of the pre-printed greeting card using the scanner 204 of the kiosk 106. In still further examples, the user 102 may scan such information utilizing an electronic device 104 separate from the kiosk 106. In such examples, the user 102 may then transfer such information to the controller 206 of the kiosk 106 at 1002 via Bluetooth, via the network, 110, via near-field communication, via Wi-Fi, etc. In such examples, it is understood that the information received from any such bar code, QR code, alphanumeric code, and/or other information feature of the greeting card may uniquely identify the greeting card.

At 1004, the controller 206 of the kiosk 106 may compare the information received at 1002 to additional greeting card identification information. Such additional identification information may be stored locally in a memory associated with the controller 206. Additionally or alternatively, such information to be stored remotely, such as within a memory associated with one or more servers or other computing devices of the remote processing center 112. At 1004, the controller 206 may identify a match between the information received at 1002 and such stored identification information, and as a result, the controller 206 may uniquely identify the particular greeting card at 1004 based at least in part on the comparison.

At 1006, the controller 206 may cause a plurality of gift provider options to be provided to the user 102 via the display 202. For example, as described above, gift items from a plurality of different merchants, retailers, service providers, and/or other gift providers may be incorporated into a gift generated using the kiosk 106. In the example method 1000, a giftable item separate from the greeting card may be generated by the kiosk 1006, and such a giftable item may include a unique value code that may be used by a recipient to redeem the one or more gift items selected by the user 102.

As noted above with respect to the method 300, FIG. 7 illustrates an example user interface 700 generated by the controller 206. Such an example user interface 700 may also be generated and/or provided to the user 102 at 1006. The example user interface 700 may include, for example, one or more messages 702 assisting the user 102 in selecting a gift provider 114 and/or a gift item to be associated with a pre-printed greeting card selected by the user 102. In the example shown in FIG. 7, such a message 702 may include a request that the user 102 select one or more gift categories provided via the user interface 700. For example, at 314, the controller 206 may cause the display 202 to display a plurality of controls 704, 706, 708, 710, 712, 714, 716, 718, 720, 722, etc. Each such control may correspond to a respective gift category. It is understood that in response to receiving an input via one such control, controller 206 may provide the user 102 with a plurality of gift provider options at 1006 corresponding to the gift category associated with the selected control.

At 1008, the controller 206 may receive a first input from the user 102. In such examples, the first input received at 1008 may be indicative of a selection of a particular gift provider 114 of the plurality of gift provider options provided to the user 102 at 1006. In such examples, at 1008 the user 102 may provide a touch input via the display 202, a voice input via the microphone 218, a gesture input via the camera 214, and/or one or more other inputs via the user interfaces 208 and/or other I/O devices 212 described above.

At 1010, the controller 206 of the kiosk 106 may request that the user 102 select a desired gift value amount associated with the gift item chosen at 1008. For example, at 1010 the controller 206 may cause a plurality of gift values and/or gift amounts to be provided to the user 102 via the display 202. As noted above with respect to the method 300, FIG. 8 illustrates an example user interface 800 generated by the controller 206. Such an example user interface 800 may also be generated and/or provided to the user 102 at 1010. The example user interface 800 may include, for example, one or more messages 802 assisting the user 102 in selecting a desired gift value corresponding to a selected gift item. In the example shown in FIG. 8, such a message 802 may include a request that the user 102 select one of a plurality of gift values and/or gift amounts provided via the user interface 800. For example, at 1010, the controller 206 may cause the display 202 to display a plurality of controls 804, 806, 808, 810, etc. Each such control may correspond to a respective gift value and/or gift amount. It is understood that in response to receiving an input via one such control, the controller 206 may provide the user 102 with a further user interface enabling the user 102 to provide payment information that is indicative of the desired gift value selected by the user 102 via the user interface 800.

At 1012, the controller 206 may receive a second input from the user 102. In such examples, the second input received at 1012 may be indicative of a selection of a desired gift value from the plurality of gift values provided to the user 102 at 1010 (e.g., via the user interface 800). In such examples, at 320 the user 102 may provide a touch input via the display 202, a voice input via the microphone 218, a gesture input via the camera 214, and/or one or more other inputs via the user interfaces 208 and/or other I/O devices 212 described above.

At 1014, the controller 206 of the kiosk 106 may request that the user 102 select a payment method. For example, at 1014 the controller 206 may cause a plurality of payment method options to be provided to the user 102 via the display 202. As noted above with respect to the method 300, FIG. 9 illustrates an example user interface 900. Such an example user interface 900 may also be generated by the controller 206 and/or provided to the user 102 at 1014. The example user interface 900 may include, for example, one or more messages 902 assisting the user 102 in selecting a particular payment method. In the example shown in FIG. 9, such a message 902 may include a request that the user 102 select one of a plurality of payment options supported by the kiosk 106. For example, at 1014, the controller 206 may cause the display 202 to display a plurality of controls 904, 906, 908, etc. As noted above, each such control may correspond to a respective payment option (e.g., credit, debit, payment through an electronic wallet accessible via an electronic device 104 of the user 102, PayPal, Apple Pay, etc.). It is understood that in response to receiving an input via one such control, controller 206 may provide the user 102 with a further user interface enabling the user 102 to provide the user's credit card number, debit card number, bank account information, PayPal credentials, and/or other payment information such that payment may be made for the pre-printed greeting card and for the additional gift item described above. It is understood, that the request made at 1014 by the controller 206 may be based at least in part on identifying the greeting card at 1004.

At 1016, the controller 206 may receive a third input from the user 102. In such examples, the third input received at 1016 may include at least part of the payment information described above with respect to 1014. In example embodiments, such payment information may include a total amount of the transaction (with any appropriate taxes of other fees) performed by the user 102 at the kiosk 106. Thus, the payment information provided at 1016 may be indicative of the desired gift value selected by the user 102 via the user interface 800. Such payment information may also be indicative of the costs associated with purchasing the pre-printed greeting card via the kiosk 106. In such examples, at 1016 the user 102 may provide a touch input via the display 202, a voice input via the microphone 218, a gesture input via the camera 214, and/or one or more other inputs via the user interfaces 208 and/or other I/O devices 212 described above.

At 1018, the controller 206 of the kiosk 106 (e.g., the value code engine 116 and/or other hardware or software components associated with the controller 206) may provide information indicative of the gift provider selected by the user 102 and/or indicative of the desired gift value received at 1012 to the remote processing center 112 via the network 110. As noted above with respect to the method 300, the remote processing center 112 may utilize such information to link the selected gift item with a corresponding provider 114 selected at 1008. The remote processing center 112 may also perform one or more operations at 1018 based at least in part on the information received from the controller 206. Such operations may include, among other things, authenticating the user 102, generating a unique value code corresponding to the selected gift item, and/or facilitating payment to the corresponding provider 114. For example, the unique value code generated by the remote processing center 112 may uniquely identify the selected gift item, the corresponding provider 114, and/or the actual gift value paid by the user 102 at 1016. The processing center 112 may use this information to allocate payment to the provider 114. The processing center 112 may also store such information such that the recipient of the gift may be authenticated when the recipient attempts to redeem the gift item using the unique value code.

At 1020, the controller 206 (e.g., the value code engine 116 and/or other hardware or software components associated with the controller 206) may receive various transaction information from the remote processing center 112. For example, at 1020 the controller 206 may receive the unique value code from the remote processing center 112. As noted above, the unique value code may correspond to and/or uniquely identify the selected gift item, the corresponding provider 114, and/or the actual gift value paid by the user 102 at 324. In such examples, the unique value code may be received at 1020 via the network 110, and the unique value code may be received at least partly in response to the information provided by the controller 206 at 1018.

At 1022, the controller 206 (e.g., the value code engine 116 and/or other hardware or software components associated with the controller 206) may cause the printer 210 to print the unique value code received at 1020 on a sticker, label, post card, and/or other giftable item separate from the pre-printed greeting card. For example, the printer 210 may print the unique value code on an adhesive sticker or other materials 220 located at or on the kiosk 106. The user 102 may then adhere, connect, insert, and/or otherwise combine the giftable item with the pre-printed greeting card such that the two items may comprise a singular gift given to the desired recipient. As described above, the gift value associated with the unique value code may be redeemed by the recipient using the unique value code.

Additionally or alternatively, in any of the examples described herein, at 1022 the controller 206 (e.g., the value code engine 116 and/or other hardware or software components associated with the controller 206) may cause the gift item corresponding to the unique value code to be transferred electronically to the recipient's digital wallet and/or other app or component of the recipient's electronic device. In examples in which one or more operations of the method 1000 are performed by the user's electronic device 104, such components of the electronic device (instead of the kiosk 106) may also cause the gift item corresponding to the unique value code to be transferred electronically to the recipient's digital wallet and/or other app or component of the recipient's electronic device. In such examples, the kiosk 106 and/or the user's electronic device 104 may also be used to generate one or more of the giftable items described above with respect to the method 1000. Such giftable items may be printed by the printer of 210 the kiosk 106, or at a stand-alone printer remote from the kiosk 106, and may be physically given to the recipient by the user 102 in combination with the gift item that has been added to the recipient's digital wallet. Alternatively, in such embodiments the giftable items may also be transferred electronically to the recipient. As still another alternative, in any of the examples described herein with respect to the method 1000, the unique value code may be emailed, texted (via SMS messaging), transferred via Bluetooth, transferred via NFC, or via other means, and/or otherwise transferred electronically to the recipient from the kiosk 106 and/or from the electronic device 104 of the user 102. In such examples, the giftable item may or may not be printed.

### Example Redemption Processes

In any of the examples described herein, once a greeting card and/or a corresponding giftable item has been gifted to a recipient, the recipient may redeem the gift item corresponding to the greeting card and/or the giftable item using the unique value code printed thereon. The redemption process may include authentication which determines whether the unique value code being used by the recipient is a valid code. Such a process may also include authorization which provides the recipient with access to the particular gift item linked to the unique value code.

In an example embodiment, the recipient may manually enter the unique value code into a data field of a specified webpage. For example, the recipient may navigate to a specific website by entering a specified uniform resource locator (URL) into an internet browser. In some examples, the URL may be printed on the greeting card or on the giftable item together with the unique value code. Once the recipient has reached the web site indicated by the URL, the recipient may view a welcome experience and obtain additional information regarding the gift item, the method for redeeming the gift item, and other facts about the purchaser, the gift item, or the redemption process. The recipient may then enter the unique code printed on the greeting card or on the giftable item into an area of the website indicated for accepting such unique value codes. When the website receives the unique value code, the website may first verify that the code is authentic. In such an example verification process, the website may request authentication from the remote processing center 112. If the unique value code is deemed authentic, the website may 1.) require the recipient to login or to setup a user login and password, or 2.) direct the recipient to a third party web site (e.g., a web site of the provider 114 from which the gift item may be redeemed) wherein the recipient is required to login or to setup a user login and password. Once the recipient has successfully logged in, the gift item is confirmed and the recipient can redeem the gift item either electronically, via mail, in-person at a retail outlet, and/or by other means. For example, if the gift item is a subscription-based physical gift, the recipient may be required to enter his/her name and delivery address and may be asked for additional information. If the gift item is a subscription-based digital gift, the recipient will be required to enter his/her name, email address and phone number and may be asked to provide additional information and to download an app which provides the recipient access to or which facilitates the recipient's use of the digital gift. In another example embodiment a mobile app operable on the electronic device 104 of the recipient may enable the recipient to activate and/or redeem a gift item associated with the unique value code by directing the recipient directly to the website of the provider 114 and/or other entity providing the gift item (e.g., Birchbox, Gamefly, etc.).

In another embodiment, the greeting card and/or the giftable item may contain a digital watermark, a QR code, an augmented reality marker or other camera or scan-based technology printed on or embedded therein. In this case, the recipient may use his/her electronic device 104 to either scan or take a picture of the scan-based technology printed on the greeting card and/or the giftable item. The information retrieved by scanning may be a Uniform Resource Locator (URL) and a unique code which specifically identifies the greeting card and/or the giftable item. The URL directs the recipient's electronic device 104 to a specific website wherein the unique value code can be entered via one or more data entry fields configured to receive the unique value code. The website may transfer the received unique value code to one or more remote servers or other devices of the processing center 112, and one or more such devices may verify that the unique value code is authentic. If successful, the website may provide the recipient with access to the gift item corresponding to the unique value code.

In another embodiment, the greeting card and/or the giftable item may contain printed electronics, foil stamping, conductive foam, or other conductive technology printed thereon or embedded therein which would enable the greeting card and/or the giftable item to communicate with a multi-touch surface of a touchscreen device, such as the electronic device 104 of the recipient. Most touch screen devices use a capacitive touch screen wherein a circuit is completed by the touch of a finger. The greeting card and/or the giftable item may contain a conductive thread which, when in contact with the display of the electronic device 104, will imitate a finger touch, tap or swipe. This allows the greeting card and/or the giftable item to initiate or trigger some action by the electronic device 104. Thus, the recipient may be directed to a particular website or directed to download a specific mobile app. Once the recipient has reached the website or mobile app, placing the greeting card and/or the giftable item on the touchscreen or other display of the recipient's electronic device 104 may initiate the authentication and redemption processes which, if successful, may provide the recipient with access to the gifted item.

In another embodiment, the greeting card and/or the giftable item may contain an augmented reality marker. In such examples, a gesture, voice, or motion detection is recognized by a website or downloaded mobile or computer app when viewed through a camera or webcam of the electronic device 104 of the recipient. In this embodiment, the recipient would reach the indicated website or download and open a specific mobile app which would prompt the recipient to aim the camera of his/her electronic device 104 at the greeting card and/or the giftable item, and to complete a specific gesture or motion-based action. For example, the recipient may be asked to wave the greeting card and/or the giftable item back and forth, or hold it next to their face and smile, or hold the greeting card and/or the giftable item in their right hand while jumping up and down. Completing the specified action would initiate the authentication and redemption processes which, if successful, may provide the recipient with access to the gifted item.

In another embodiment, the greeting card and/or the giftable item may contain an RFID chip (or other NFC technology). To redeem a gift item using such a greeting card and/or giftable item, the user recipient may be instructed to download an app to his/her electronic device 104, and such an electronic device 104 may include an NFC reader. With the app open, placing the greeting card and/or the giftable item on or near the electronic device 104 may initiate the authentication and redemption processes which, if successful, may provide the recipient with access to the gifted item.

### Conclusion

Unless otherwise defined, all technical terms used herein have the same meaning as commonly understood by one having ordinary skill in the art to which this invention applies. The examples set forth herein are intended to describe particular embodiments only and are not intended to limit the invention in any way.

The term “network” as used herein includes, but is not limited to: a collection of hardware components and computer or machines interconnected by communications channels that allow sharing of resources and information, including, without limitation, the worldwide web or the internet.

The term “server” as used herein, includes, but is not limited to: a computer or machine (physical or virtual) or a device on a network that manages network resources. The general term “server” may include specific types of servers such as an application server (a computer which executes specific logic in software/computer programs), a file server (a computer and storage device dedicated to storing files), a print server (a computer that manages one or more printers), a network server (a computer than manages network traffic), and a database server (a computer system that processes database queries). Although servers are frequently dedicated to performing only server tasks, certain multiprocessing operating systems allow a server to manage other non-server related resources. A “web server” as used herein, includes, but is not limited to: a server which serves content to a web browser by lading a file from a disk and serving it across a network to a user's web browser, typically using a HTTP.

The term “software” or “computer program” as used herein includes, but is not limited to: one or more computer or machine readable and/or executable instructions that cause a computer, microprocessor, logic circuit, or other electronic device to perform functions, actions and/or behave in a desired manner. The instructions may be embodied in various forms such as routines, algorithms, modules or programs including separate applications or code from dynamically linked libraries. Software may also be implemented in various forms such as stand-alone programs, apps, a function call, a servlet, an applet, instructions stored in a memory or any other computer readable medium, part of an operating system of other type of executable instructions. It will be appreciated by one of ordinary skill in the art that the form of software is dependent on, for example, requirements of a desired application, the environment it runs on, and/or the desires of a designer/programmer or the like.

The term “web browser” as used herein, includes, but is not limited to: a software for retrieving and presenting information resources on the worldwide web. An information resource may be a web page, an image, a video, or any other type of electronic content.

“Electronic Devices”, as used herein, includes, but is not limited to a phone (e.g., a mobile phone), a smartphone, a tablet, a personal data assistant (PDA), a notebook, a personal computer, a laptop computer, a smart TV, a handheld or console-based game system, a digital media receiver (e.g. Apple TV, Roku), a smart digital video disc (DVD) player, a smart device (e.g., Alexa by Amazon, Google Home, and/or other devices in communication via and/or associated with the internet of things), and wearable devices (e.g., smart watch). Any of the processes described herein may be performed by one or more such electronic communication devices. In particular, any of the selection, generation, purchasing, activation, redemption, and or other processes described herein may be performed by one or more such electronic communication devices even if such processes are described herein only with respect to, for example, a mobile phone, a kiosk 106, and or other devices.

“Mobile application” or “Mobile App” or “App” as used herein, includes, but is not limited to: applications that run on mobile phones, tablet computers and other mobile devices. The terms “mobile application”, “mobile app” and “app” can be used synonymously with “software”. Mobile applications allow users to connect to services which are traditionally available on a desktop or notebook platforms. Typically, these services access the internet or intranet or cellular or wireless fidelity networks to access, retrieve, transmit and share data.

The terms “computer”, “processor” or “processing unit” as used herein, includes, but is not limited to: any programmed or programmable electronic device, microprocessor, logic unit that can store, retrieve and process data.

“API files” or “API” or “Application Programming Interface” as used herein, includes, but is not limited to: an interface between different software programs or software files which facilitate the interaction of the different software programs or software files by way of a specific set of rules and specifications.

The foregoing embodiments and/or examples of the present disclosure have been presented for the purposes of illustration and description. These descriptions and embodiments are not intended to be exhaustive or to limit the disclosure to the precise form disclosed, and obviously many modifications and variations are possible in light of the above disclosure. The embodiments were chosen and described in order to best explain the principle of the disclosure and its practical application to thereby enable others skilled in the art to best utilize the invention in its various embodiments and with various modifications as are suited to the particular use contemplated.

1. A kiosk, comprising:
a display;
a printer; and
a controller connected to the display and the printer, the controller being in communication with memory storing a set of instructions which, when executed by the controller, cause the controller to perform operations including:
causing a plurality of greeting card options to be provided via the display;
receiving a first input indicative of a selection of a particular greeting card of the plurality of greeting card options;
causing a plurality of gift provider options to be provided via the display;
receiving a second input indicative of a selection of a particular gift provider of the plurality of gift provider options;
receiving a third input including payment information, the payment information being indicative of a desired gift value;
receiving a unique value code corresponding to the particular gift provider from a remote processing center and via a network to which to the controller is connected, wherein the desired gift value is redeemable from the particular gift provider using the value code; and
causing the printer to print the particular greeting card including the unique value code.

2. The kiosk of claim 1, wherein the operations further include
causing a plurality of occasion options to be provided via the display; and
receiving a fourth input indicative of a selection of a particular occasion option of the plurality of occasion options, wherein the particular greeting card is printed based at least in part on the particular occasion option.

3. The kiosk of claim 2, wherein causing the plurality of greeting card options to be provided includes displaying a plurality of thumbnails via the display, each thumbnail of the plurality of thumbnails being representative of a respective greeting card corresponding to the particular occasion.

4. The kiosk of claim 1, wherein the operations further include
requesting customized content via the display and at least partly in response to receiving the first input; and
receiving a fourth input via a user interface of the kiosk, the fourth input comprising at least one of a customized greeting, a customized message, or a customized signature, wherein the particular greeting card is printed based at least in part on the fourth input.

5. The kiosk of claim 1, wherein the operations further include receiving one or more digital photos from an electronic device separate from the kiosk, wherein the particular greeting card is printed based at least in part on the one or more digital photos.

6. The kiosk of claim 1, wherein the operations further include providing information indicative of the particular gift provider and the desired gift value to the remote processing center via the network, the unique value code being received at least partly in response to the information indicative of the particular gift provider and the desired gift value.

7. The kiosk of claim 1, wherein the operations further include
causing a plurality of gift values to be provided via the display; and
receiving a fourth input indicative of a selection of the desired gift value from the plurality of gift values.

8. The kiosk of claim 1, wherein the operations further include providing a preview of at least part of the particular greeting card via the display prior to causing the printer to print the particular greeting card.

9. A kiosk, comprising:
a display;
a printer; and
a controller connected to the display and the printer, the controller being in communication with memory storing a set of instructions which, when executed by the controller, cause the controller to perform operations including:
causing a plurality of gift provider options to be provided via the display;
receiving a first input indicative of a selection of a particular gift provider of the plurality of gift provider options;
receiving a second input including payment information, the payment information being indicative of a desired gift value;
receiving a unique value code corresponding to the particular gift provider from a remote processing center and via a network to which to the controller is connected, wherein the desired gift value is redeemable from the particular gift provider using the value code; and
causing the printer to print the unique value code on a giftable item.

10. The kiosk of claim 9, wherein the operations further include receiving information from an information feature disposed on a greeting card separate from the giftable item, the information uniquely identifying the greeting card.

11. The kiosk of claim 10, wherein the operations further include
comparing the information to stored greeting card identification information;
identifying the greeting card based at least in part on the comparison; and
requesting the payment information based at least in part on identifying the greeting card.

12. The kiosk of claim 10, further comprising a scanner connected to the controller, and wherein the information received from the information feature is received using the scanner.

13. The kiosk of claim 9, wherein the giftable item comprises one of a sticker or cardstock.

14. The kiosk of claim 9, wherein the operations further include providing information indicative of the particular gift provider and the desired gift value to the remote processing center via the network, the unique value code being received at least partly in response to the information indicative of the particular gift provider and the desired gift value.

15. The kiosk of claim 9, wherein the operations further include
causing a plurality of gift values to be provided via the display; and
receiving a third input indicative of a selection of the desired gift value from the plurality of gift values.

16. A method, comprising:
causing, with a controller, a plurality of gift provider options to be provided via a display;
receiving, with the controller, a first input indicative of a selection of a particular gift provider of the plurality of gift provider options;
receiving, with the controller, a second input indicative of a desired gift value;
requesting, with the controller and via the display, payment information corresponding to at least the desired gift value;
receiving, with the controller, a third input including payment information indicative of the desired gift value;
providing, with the controller, information indicative of the particular gift provider and the desired gift value to a remote processing center via a network with which the controller is connected;
receiving, with the controller, a unique value code corresponding to the particular gift provider from the remote processing center and via the network, wherein the desired gift value is redeemable from the particular gift provider using the value code; and
causing, with the controller, a printer to print the unique value code on one of a greeting card or giftable item separate from the greeting card.

17. The method of claim 16, wherein the controller comprises a controller of a mobile electronic device, and the printer comprises a printer of a kiosk separate from the mobile electronic device.

18. The method of claim 16, further including
causing a plurality of greeting card options to be provided via the display;
receiving a fourth input indicative of a selection of a particular greeting card of the plurality of greeting card options; and
causing the printer to print the particular greeting card including the unique value code.

19. The method of claim 18, further including
causing a plurality of occasion options to be provided via the display;
receiving a fifth input indicative of a selection of a particular occasion of the plurality of occasion options, wherein each greeting card option of the plurality of greeting card options is provided based at least in part on the selection of the particular occasion.

20. The method of claim 16, further including
receiving information from an information feature disposed on a greeting card, the information uniquely identifying the greeting card.
comparing the information from the information feature to stored greeting card identification information;
identifying the greeting card based at least in part on the comparison; and
requesting the payment information based at least in part on identifying the greeting card.
